(19) United States
(12) Patent Application Publication
(10) Pub. No.: US 2024/0101161 A1
(43) Pub. Date: Mar. 28, 2024

(54) METHODS AND APPARATUS FOR STATE-BASED ATTACK DETECTION

(71) Applicant: Nuro, Inc., Mountain View, CA (US)

(72) Inventors: Geoff Janjua, Mountain View, CA (US); Robert Leonard, Port Chester, NY (US); John Fitzgerald, Longmeadow, MA (US); Scott Sheahan, Dearborn, MI (US)

(73) Assignee: Nuro, Inc., Mountain View, CA (US)

(21) Appl. No.: 18/162,440

(22) Filed: Jan. 31, 2023

Related U.S. Application Data
(60) Provisional application No. 63/307,454, filed on Feb. 7, 2022.

(51) Int. Cl. B60W 60/00; B60R 25/30

(52) U.S. Cl. CPC B60W 60/007; B60R 25/30; B60W 60/005

(57) ABSTRACT

According to one aspect, a method includes obtaining a command on a vehicle, the command being arranged to identify a first action to be taken by the vehicle, wherein the vehicle is in a first vehicle state and the command has a first command state. The method also includes determining, on the vehicle, whether the first command state is consistent with the first vehicle state. When it is determined that the first command state is consistent with the first vehicle state, the method includes executing the first command. When it is determined that the first command state is not consistent with the first vehicle state, the method includes identifying the first command as an illegitimate command and ignoring the illegitimate command.

### PRIORITY CLAIM

This patent application claims the benefit of priority under 35 U.S.C. § 119 to U.S. Provisional Patent Application No. 63/307,454, filed Feb. 7, 2022, and entitled “Methods and Apparatus for State-Based Attack Detection,” which is incorporated herein by reference in its entirety.

### TECHNICAL FIELD

The disclosure relates to providing systems for use with autonomous vehicles. More particularly, the disclosure relates to detecting and responding to attacks on autonomous vehicles by malicious actors.

### BACKGROUND

As the use of autonomous vehicles proliferates, the ability for autonomous vehicles to operate safely is increasing. When an autonomous vehicle operates safely, the likelihood that other road users such as motorists and pedestrians may be injured by the autonomous vehicle may effectively be minimized. The safety with which an autonomous vehicle may operate may be compromised in some instances if a malicious actor sends commands to the autonomous vehicle. For example, a malicious actor may send a command to the autonomous vehicle to deviate off of a planned path, and a deviation from a planned path may pose safety concerns.

### BRIEF DESCRIPTION OF THE DRAWINGS

The disclosure will be readily understood by the following detailed description in conjunction with the accompanying drawings in which:

FIG. 1 is a diagrammatic representation of an autonomous vehicle fleet in accordance with an embodiment.

FIG. 2 is a diagrammatic representation of a side of an autonomous vehicle in accordance with an embodiment.

FIG. 3 is a block diagram representation of an autonomous vehicle in accordance with an embodiment.

FIG. 4 is a block diagram representation of a state-based attack detection arrangement, e.g., state-based attack detection arrangement 330 of FIG. 3, in accordance with an embodiment.

FIG. 5 is a process flow diagram which illustrates a method of processing a command received by an autonomous vehicle in accordance with an embodiment.

FIG. 6 is a process flow diagram which illustrates a first method of implementing a remedial process, e.g., step 533 of FIG. 5, in accordance with an embodiment.

FIG. 7 a process flow diagram which illustrates a second method of implementing a remedial process, e.g., step 533 of FIG. 5, in accordance with an embodiment.

FIG. 8 is a diagrammatic representation of a response to an illegitimate command obtained by a vehicle in accordance with an embodiment.

FIG. 9 is a process flow diagram which illustrates a method of responding to an illegitimate command in accordance with an embodiment.

### DESCRIPTION OF EXAMPLE EMBODIMENTS

### General Overview

According to one aspect, a method includes obtaining a command on a vehicle, the command being arranged to identify a first action to be taken by the vehicle, wherein the vehicle is in a first vehicle state and the command has a first command state. The method also includes determining, on the vehicle, whether the first command state is consistent with the first vehicle state. When it is determined that the first command state is consistent with the first vehicle state, the method includes executing the first command. When it is determined that the first command state is not consistent with the first vehicle state, the method includes identifying the first command as an illegitimate command and ignoring the illegitimate command.

In one embodiment, a vehicle includes a chassis, a propulsion system, a power system, a first compute system, and an autonomy system. The propulsion system propels the chassis, while the power system, first compute system, and autonomy system are all carried on the chassis. The first compute system includes an attack detection system configured to obtain a command provided to the vehicle. The command has a first command state, and the attack detection system is configured to determine whether the first command state is consistent with a current vehicle state of the vehicle. When the first compute system determines that the first command state is not consistent with the current vehicle state, the first compute system identifies the command as an illegitimate command and notifies the autonomy system of the illegitimate command. The autonomy system is arranged to identify an appropriate action to take in response to the illegitimate command and to execute the appropriate action.

In another embodiment, a vehicle includes logic encoded in one or more tangible non-transitory, computer-readable media for execution. When executed, the logic is operable to obtain a command arranged to identify a first action to be taken by the vehicle, wherein the vehicle is in a first vehicle state and the command has a first command state. The logic is also operable to determine whether the first command state is consistent with the first vehicle state, execute the first command when it is determined that the first command state is consistent with the first vehicle state, and to identify the first command as an illegitimate command when it is determined that the first command state is not consistent with the first vehicle state. The logic causes the illegitimate command to be ignored after it identifies the first command as the illegitimate command.

When a vehicle such as an autonomous vehicle receives a command, the vehicle may determine whether the command is legitimate before acting on the command. Determining whether a command is legitimate includes ascertaining whether a state of the command is substantially consistent with a state of the vehicle. If the state of the command is substantially consistent with the state of the vehicle, then the command is identified as legitimate, and the vehicle may execute or otherwise follow the command. Alternatively, if the command is inconsistent with the state of the vehicle, then the vehicle may implement remedial measures with respect to the inconsistent or illegitimate command. Remedial measures may include preventing additional commands from being received by the vehicle from the source of the illegitimate command.

### DESCRIPTION

Vehicles, when operating in an autonomous mode, may receive or otherwise obtain commands that contain instructions which the vehicles are expected to execute. For example, while driving to a first destination, the vehicle may receive a command to drive instead to a second destination and may be expected to take action by aborting the drive to the first destination and instead drive to the second destination.

An autonomous vehicle may be subjected to attacks, e.g., attacks from malicious actors, which are intended to cause the autonomous vehicle to take substantially unauthorized or unsafe actions. For example, an attack may be intended to cause the autonomous vehicle to crash, or an attack may be intended to cause an autonomous vehicle which is carrying a delivery to drive to an unauthorized location at which someone may attempt to steal the delivery.

Some attacks may involve commands which may be legitimate in some situations, but illegitimate in other situations. That is, a command or an instruction issued to an autonomous vehicle may be legitimate when the autonomous vehicle is in a particular state or mode, but the same command or instruction may be illegitimate when the autonomous vehicle is in a different state or mode. By way of example, a command to update firmware on an autonomous vehicle may be legitimate when the autonomous vehicle is in a maintenance state and not driving, but the same command may be illegitimate when the autonomous vehicle is in an operational state and driving. The ability to identify whether a command which may be legitimate in some situations is actually legitimate given a current behavioral state of an autonomous vehicle enables the vehicle to respond appropriately to the command.

By comparing a state of a command with a behavioral state of an autonomous vehicle, it may be determined whether the command is legitimate or illegitimate. When the command state is inconsistent with the behavioral state, e.g., when the behavioral state is such that the command may be considered to be unsuitable or inappropriate in view of the behavioral state, the autonomous vehicle may effectively detect a potential attack, and may avoid executing instructions associated with the command. As a result, the potential attack may be substantially thwarted. It should be appreciated that if a command state is consistent with a behavioral state of an autonomous vehicle, the autonomous vehicle may take actions indicated by instructions associated with the command.

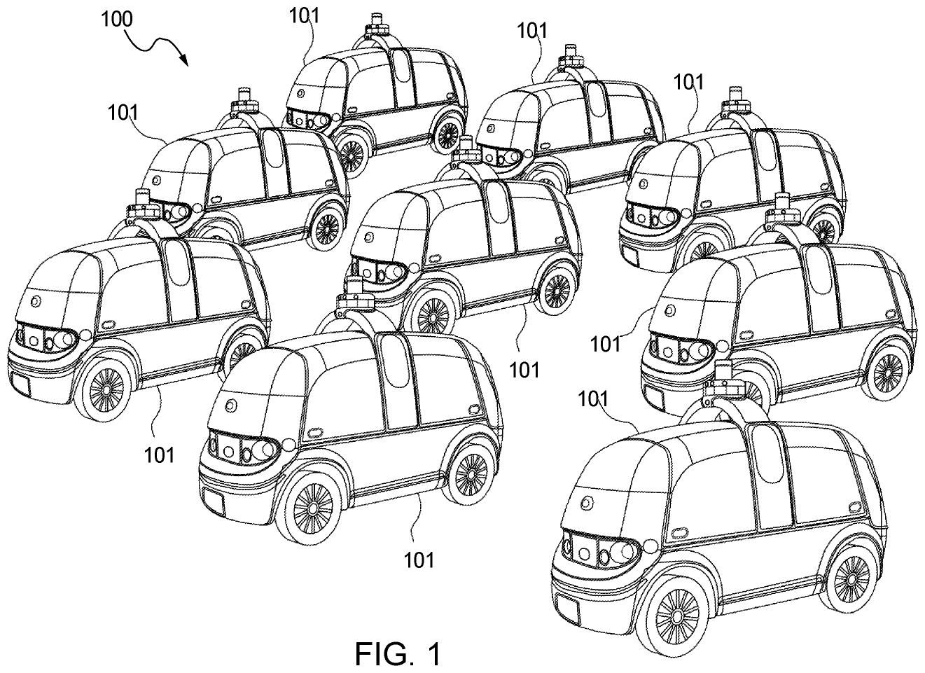

Autonomous vehicles are often part of a fleet that is managed by a fleet manager. Referring initially to FIG. 1, an autonomous vehicle fleet will be described in accordance with an embodiment. An autonomous vehicle fleet 100 includes a plurality of autonomous vehicles 101, or robot vehicles. Autonomous vehicles 101 are generally arranged to transport and/or to deliver cargo, items, and/or goods. Autonomous vehicles 101 may be fully autonomous and/or semi-autonomous vehicles. In general, each autonomous vehicle 101 may be a vehicle that is capable of travelling in a controlled manner for a period of time without intervention, e.g., without human intervention. As will be discussed in more detail below, each autonomous vehicle 101 may include a power system, a propulsion or conveyance system, a navigation module, a control system or controller, a communications system, a processor, and a sensor system.

Dispatching of autonomous vehicles 101 in autonomous vehicle fleet 100 may be coordinated by a fleet management module (not shown). The fleet management module may dispatch autonomous vehicles 101 for purposes of transporting, delivering, and/or retrieving goods or services in an unstructured open environment or a closed environment.

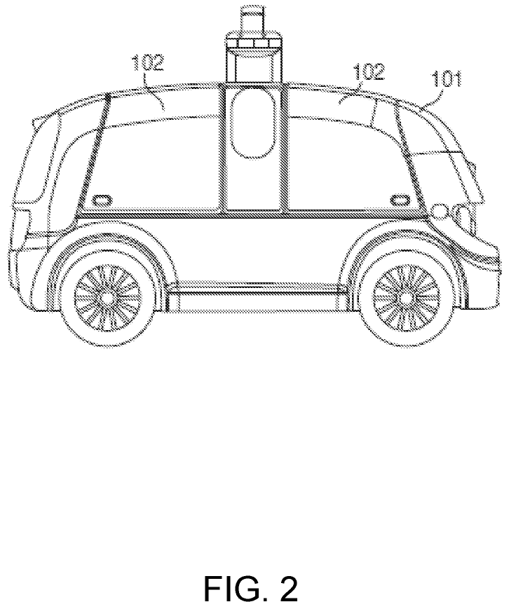

FIG. 2 is a diagrammatic representation of a side of an autonomous vehicle, e.g., one of autonomous vehicles 101 of FIG. 1, in accordance with an embodiment. Autonomous vehicle 101, as shown, is a vehicle configured for land travel. Typically, autonomous vehicle 101 includes physical vehicle components such as a body or a chassis, as well as conveyance mechanisms, e.g., wheels. In one embodiment, autonomous vehicle 101 may be relatively narrow, e.g., approximately two to approximately five feet wide, and may have a relatively low mass and relatively low center of gravity for stability. Autonomous vehicle 101 may be arranged to have a working speed or velocity range of between approximately one and approximately forty-five miles per hour (mph), e.g., approximately twenty-five miles per hour. In some embodiments, autonomous vehicle 101 may have a substantially maximum speed or velocity in range between approximately thirty and approximately ninety mph.

Autonomous vehicle 101 includes a plurality of compartments 102. Compartments 102 may be assigned to one or more entities, such as one or more customer, retailers, and/or vendors. Compartments 102 are generally arranged to contain cargo, items, and/or goods. Typically, compartments 102 may be secure compartments. It should be appreciated that the number of compartments 102 may vary. That is, although two compartments 102 are shown, autonomous vehicle 101 is not limited to including two compartments 102.

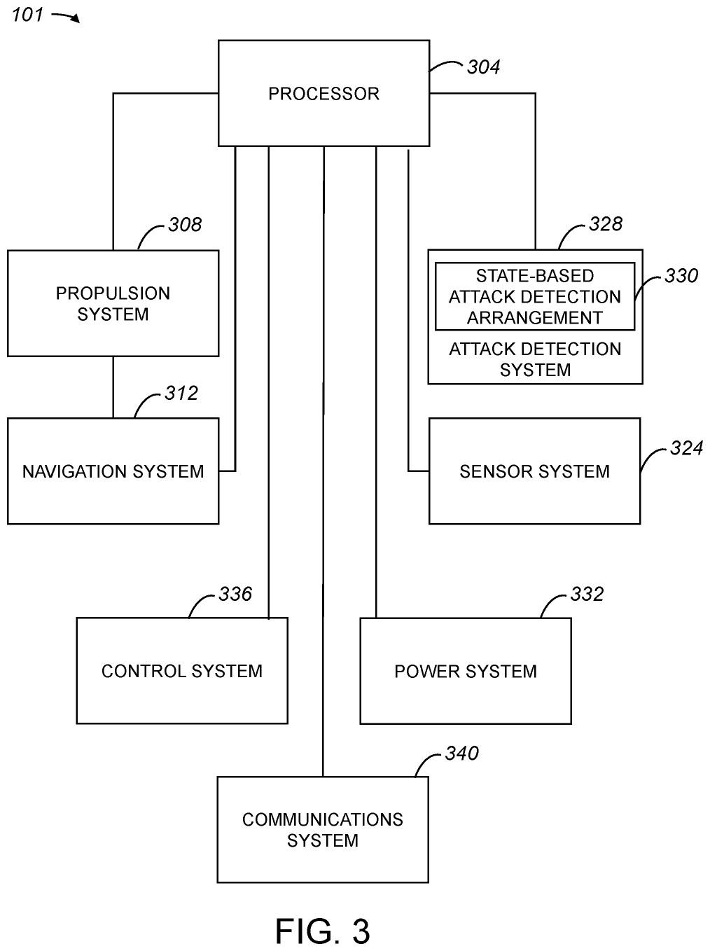

FIG. 3 is a block diagram representation of an autonomous vehicle, e.g., autonomous vehicle 101 of FIG. 1, in accordance with an embodiment. An autonomous vehicle 101 includes a processor 304, a propulsion system 308, a navigation system 312, a sensor system 324, an attack detection system 328, a power system 332, a control system 336, and a communications system 340. It should be appreciated that processor 304, propulsion system 308, navigation system 312, sensor system 324, power system 332, and communications system 340 are all coupled to a chassis or body of autonomous vehicle 101.

Processor 304 is arranged to send instructions to and to receive instructions from or for various components such as propulsion system 308, navigation system 312, sensor system 324, power system 332, and control system 336. Propulsion system 308, or a conveyance system, is arranged to cause autonomous vehicle 101 to move, e.g., drive. For example, when autonomous vehicle 101 is configured with a multi-wheeled automotive configuration as well as steering, braking systems and an engine, propulsion system 308 may be arranged to cause the engine, wheels, steering, and braking systems to cooperate to drive. In general, propulsion system 308 may be configured as a drive system with a propulsion engine, wheels, treads, wings, rotors, blowers, rockets, propellers, brakes, etc. The propulsion engine may be a gas engine, a turbine engine, an electric motor, and/or a hybrid gas and electric engine.

Navigation system 312 may control propulsion system 308 to navigate autonomous vehicle 101 through paths and/or within unstructured open or closed environments. Navigation system 312 may include at least one of digital maps, street view photographs, and a global positioning system (GPS) point. Maps, for example, may be utilized in cooperation with sensors included in sensor system 324 to allow navigation system 312 to cause autonomous vehicle 101 to navigate through an environment.

Sensor system 324 includes any sensors, as for example LiDAR, radar, ultrasonic sensors, microphones, altimeters, and/or cameras. Sensor system 324 generally includes onboard sensors which allow autonomous vehicle 101 to safely navigate, and to ascertain when there are objects near autonomous vehicle 101. In one embodiment, sensor system 324 may include propulsion systems sensors that monitor drive mechanism performance, drive train performance, and/or power system levels. Data collected by sensor system 324 may be used by a perception system associated with navigation system 312 to determine or to otherwise understand an environment around autonomous vehicle 101.

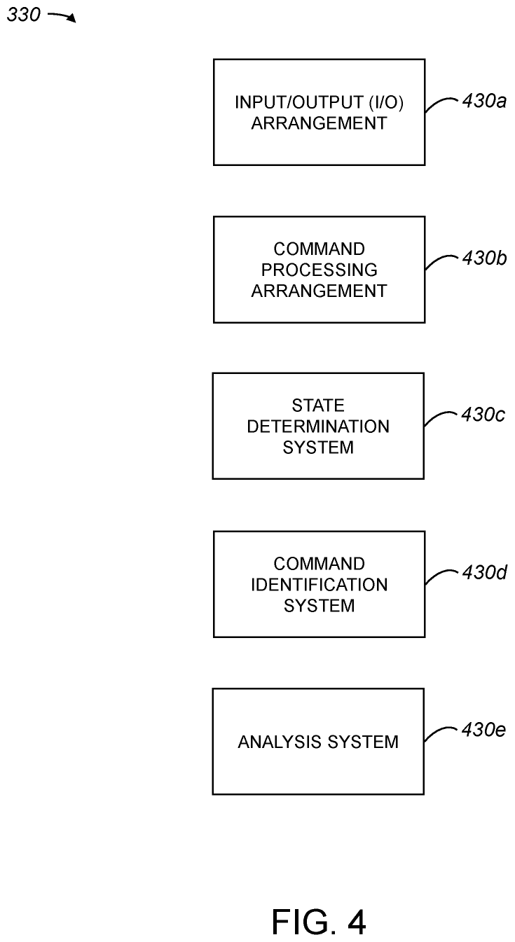

Attack detection system 328 is configured to detect or to otherwise identify when a malicious user is attempting to attack vehicle 101, e.g., to take control of vehicle 101 with ill or malicious intent. An attack detection system 328 may generally determine when an inconsistent command is received or otherwise obtained. For example, a command to drive vehicle 101 into an obstacle may be an inconsistent command. In one embodiment, attack detection system 328 includes a state-based attack detection arrangement 330. State-based attack detection arrangement 330 is configured to determine when an attempted attack on vehicle 101 is state-based. A state-based attack may generally be an attack that, in some circumstances, may be legitimate. A command may be legitimate if obtained while vehicle 101 is in a particular behavior state, and illegitimate if obtained while vehicle 101 is in a different behavior state. For instance, a command to perform maintenance on vehicle 101 may be legitimate if obtained while vehicle 101 is parked at a maintenance location and may be substantially illegitimate if vehicle 101 is currently operating on a road. One embodiment of state-based attack detection arrangement 330 will be discussed below with reference to FIG. 4.

Power system 332 is arranged to provide power to autonomous vehicle 101. Power may be provided as electrical power, gas power, or any other suitable power, e.g., solar power or battery power. In one embodiment, power system 332 may include a main power source, and an auxiliary power source that may serve to power various components of autonomous vehicle 101 and/or to generally provide power to autonomous vehicle 101 when the main power source does not have the capacity to provide sufficient power.

Communications system 340 allows autonomous vehicle 101 to communicate, as for example, wirelessly, with a fleet management system (not shown) that allows autonomous vehicle 101 to be controlled remotely. Communications system 340 generally obtains or receives data, stores the data, and transmits or provides the data to a fleet management system and/or to autonomous vehicles 101 within a fleet 100. The data may include, but is not limited to including, information relating to scheduled requests or orders, information relating to on-demand requests or orders, and/or information relating to a need for autonomous vehicle 101 to reposition itself, e.g., in response to an anticipated demand.

In some embodiments, control system 336 may cooperate with processor 304 to determine where autonomous vehicle 101 may safely travel, and to determine the presence of objects in a vicinity around autonomous vehicle 101 based on data, e.g., results, from sensor system 324. In other words, control system 336 may cooperate with processor 304 to effectively determine what autonomous vehicle 101 may do within its immediate surroundings. Control system 336 in cooperation with processor 304 may essentially control power system 332 and navigation system 312 as part of driving or conveying autonomous vehicle 101. Additionally, control system 336 may cooperate with processor 304 and communications system 340 to provide data to or obtain data from other autonomous vehicles 101, a management server, a global positioning server (GPS), a personal computer, a teleoperations system, a smartphone, or any computing device via the communication module 340. In general, control system 336 may cooperate at least with processor 304, propulsion system 308, navigation system 312, sensor system 324, and power system 332 to allow vehicle 101 to operate autonomously. That is, autonomous vehicle 101 is able to operate autonomously through the use of an autonomy system that effectively includes, at least in part, functionality provided by propulsion system 308, navigation system 312, sensor system 324, power system 332, and control system 336. Components of propulsion system 308, navigation system 312, sensor system 324, power system 332, and control system 336 may effectively form a perception system that may create a model of the environment around autonomous vehicle 101 to facilitate autonomous or semi-autonomous driving.

Autonomous vehicle 101 may be configured such that the functionality of various systems such as processor 304, propulsion system 308, navigation system 312, sensor system 324, power system 332, control system 336, and communications system 340 may be configured as compute systems, as for example a brain stem compute system and an autonomy compute system. That is, systems included in autonomous vehicle 101 may be substantially divided between a brain stem compute system and an autonomy compute system. In one embodiment, attack detection system 328 may be arranged as part of a brain stem compute system and/or an autonomy compute system. In general, a brain stem compute system coordinates safety-critical components of autonomous vehicle 101, monitors propulsion system 308, monitors power system 332, controls a body control module (not shown) which controls doors on compartments and the like, and/or facilitates transitioning between autonomous operation and other operations such as manual operation.

As will be appreciated by those skilled in the art, when autonomous vehicle 101 operates autonomously, vehicle 101 may generally operate, e.g., drive, under the control of an autonomy system. That is, when autonomous vehicle 101 is in an autonomous mode, autonomous vehicle 101 is able to generally operate without a driver or a remote operator controlling autonomous vehicle. In one embodiment, autonomous vehicle 101 may operate in a semi-autonomous mode or a fully autonomous mode. When autonomous vehicle 101 operates in a semi-autonomous mode, autonomous vehicle 101 may operate autonomously at times and may operate under the control of a driver or a remote operator at other times. When autonomous vehicle 101 operates in a fully autonomous mode, autonomous vehicle 101 typically operates substantially only under the control of an autonomy system. The ability of an autonomous system to collect information and extract relevant knowledge from the environment provides autonomous vehicle 101 with perception capabilities. For example, data or information obtained from sensor system 324 may be processed such that the environment around autonomous vehicle 101 may effectively be perceived.

As previously mentioned, a command issued to a vehicle such as an autonomous vehicle may be considered to be legitimate in some circumstances, and illegitimate in other circumstances. As such, state-based attack detection arrangement 330 may generally enable a determination of whether a state of a command that may be legitimate in some conditions is actually legitimate given a current behavioral state of vehicle 101. FIG. 4 is a block diagram representation of a state-based attack detection arrangement, e.g., state-based attack detection arrangement 330 of FIG. 3, in accordance with an embodiment. State-based attack detection arrangement 330 includes an input/output (I/O) arrangement 430a, a command processing arrangement 430b, a state determination system 430c, a command identification system 430d, and an analysis system 430e.

I/O arrangement 430a is configured to receive or to otherwise obtain a command that is issued or made to a vehicle, e.g., autonomous vehicle 101 of FIGS. 2 and 3. Once the vehicle obtains the command, the command may be provided to state-based attack detection arrangement 330 through I/O arrangement 430a.

Command processing arrangement 430b is configured, in one embodiment, to process a command obtained through I/O arrangement 430a. Command processing arrangement 430b may cooperate with state determination system 430c, command identification system 430b, and analysis system 430e to effectively respond to a command.

State determination system 430c may be arranged to determine a state of the vehicle, e.g., autonomous vehicle 101 of FIGS. 2 and 3. The state of the vehicle, or the behavioral state of the vehicle, may vary widely. For example, the state of the vehicle may be, but is not limited to being, an operational state such as a driving state, a parked state, and/or a maintenance state. State determination system 430c may utilize information obtained from components of a vehicle, e.g., sensors included in sensor system 324 of vehicle 101 of FIG. 3, to determine the state of the vehicle.

Command identification system 430d may be arranged to process a command that is received or obtained in order to identify the command. That is, command identification system 430d identifies instructions included in command to identify one or more actions that are to be taken. A command may be identified as, but is not limited to being identified as, a driving command, a stopping command, and/or a maintenance command.

Analysis system 430e is configured to essentially analyze a state of a command and a state of a vehicle such as vehicle 101 of FIG. 3. In one embodiment, analysis system 430e compares the state of the command and the current state of the command to determine whether the command is legitimate and whether the command is illegitimate. When a command is determined by analysis system 430e to be legitimate and, hence, may be followed, or whether the command is determined to be illegitimate and, hence, is not to be followed. It should be appreciated that a command may be determined to be illegitimate if the command is otherwise legitimate, but received or obtained when the vehicle is in a behavior state that is inconsistent with the command. That is, when a command that is generally legitimate, as for example when a vehicle is in a first state, is effectively received when the vehicle is in a second state, an analysis performed by analysis system 430e may determine that the command is not legitimate and identify the command as not being legitimate.

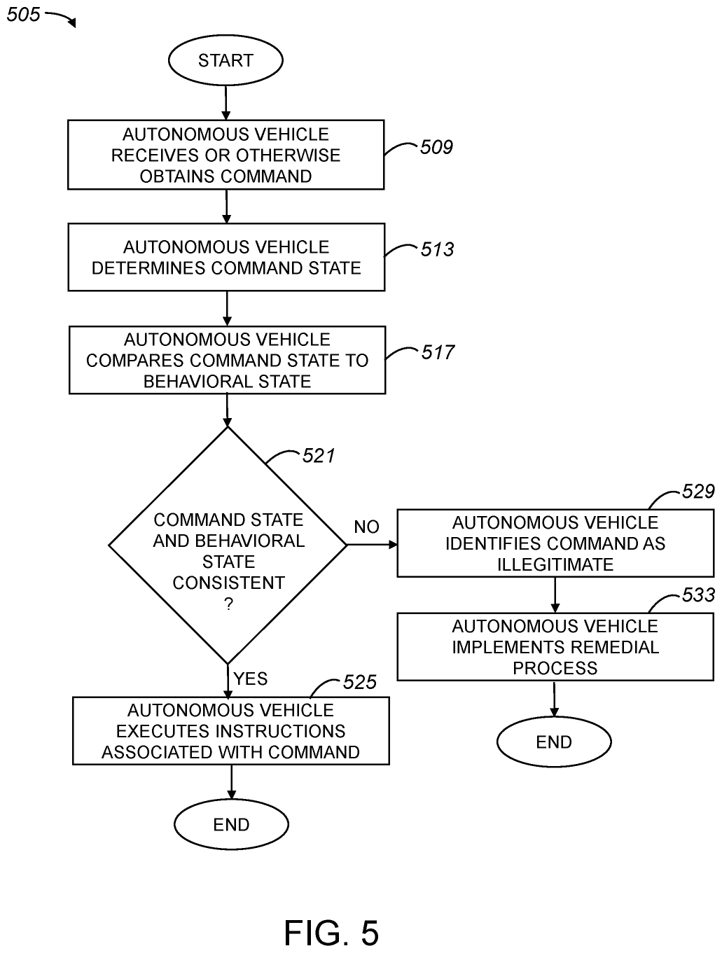

Referring next to FIG. 5, a method of processing a command received by or otherwise obtained by an autonomous vehicle will be discussed in accordance with an embodiment. A method 505 of processing a command received by an autonomous vehicle begins at a step 509 in which the autonomous vehicle receives or otherwise obtains a command. The command may be received wirelessly by the autonomous vehicle while operating in a fully autonomous or semi-autonomous mode.

Once the command is received, the autonomous vehicle determines or identifies a command state associated with the command in a step 513. For example, the autonomous vehicle may identify the instructions included in the command as well as any actions that the instructions, if accepted, would effectively be executed by the autonomous vehicle.

In a step 517, the autonomous vehicle compares the command state identified in step 513 to a behavioral state of the autonomous vehicle. The behavioral state of the autonomous vehicle may include, but is not limited to including, a state which indicates whether the autonomous vehicle is currently operating.

A determination is made in a step 521 as to whether the command state and the behavioral state are consistent. That is, it is determined whether the command state associated with the command are effectively legitimate given the current behavioral state of the vehicle. By way of example, if a command state is associated with a maintenance action and the behavioral state indicates that the vehicle is driving to a destination, the command state and the behavioral state may be determined to be inconsistent. In another example, if a command state is associated with a firmware update and the behavioral state indicates that the vehicle is driving, the command state and the behavioral state may be determined to be inconsistent.

If the determination in step 521 is that the command state and the behavioral state are consistent, the implication is that the command received in step 509 is legitimate. Accordingly, in a step 525, the autonomous vehicle executes the instructions associated with the command, and the method of processing a command received by an autonomous vehicle is completed.

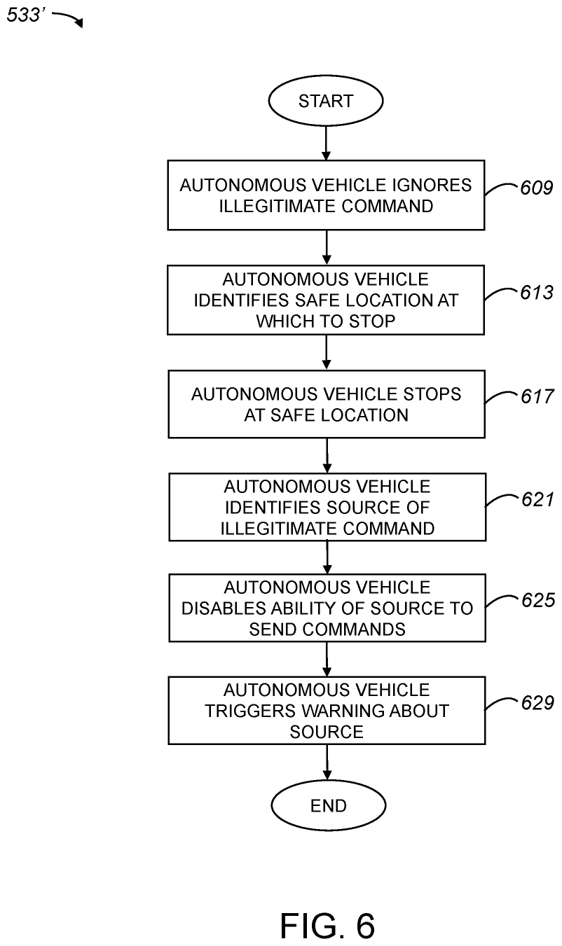

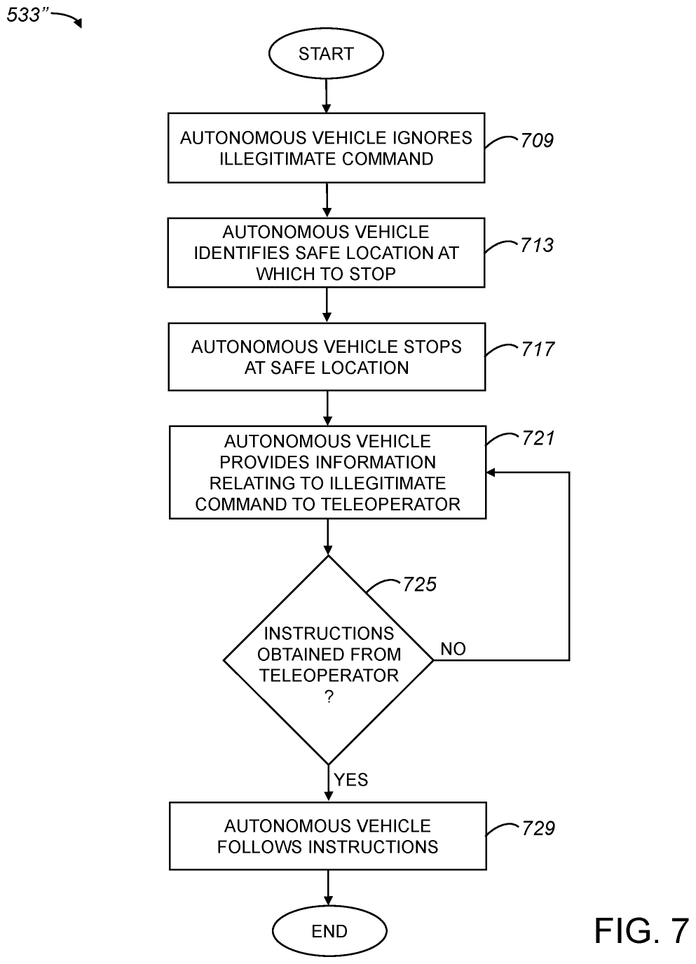

Alternatively, if it is determined in step 521 that the command state and the behavioral state are not consistent, the indication is generally that the command may have been sent or provided by a malicious actor. For example, the command may be associated with a malicious attack on the vehicle. As such, process flow moves from step 521 to a step 529 in which the autonomous vehicle identifies the command as illegitimate Then, in a step 533, the autonomous vehicle implements a remedial process. A remedial process may generally address the illegitimate or inconsistent command. Methods of implementing a remedial process will be discussed below with respect to FIGS. 6 and 7. Upon the implementation of a remedial process, the method of processing a command received by an autonomous vehicle is completed.

FIG. 6 is a process flow diagram which illustrates a first method of implementing a remedial process, e.g., step 533 of FIG. 5, in accordance with an embodiment. A method 533′ of implementing a remedial process upon receipt of an illegitimate command begins at a step 609 in which the autonomous vehicle effectively ignores the illegitimate command. By way of example, the autonomous vehicle may not execute actions indicated by the instructions associated with the illegitimate command.

In a step 613, the autonomous vehicle identifies a safe location at which to stop. After identifying a safe location at which to stop, the autonomous vehicles comes to a stop at the safe location in a step 617.

Once the autonomous vehicle is stopped, the autonomous vehicle identifies a source of the illegitimate command in a step 621. Identifying the source may include, but is not limited to including, parsing data included in the command to identify the source, The source is then disabled in a step 625. Disabling the source may include setting parameters associated with the autonomous vehicle which indicate that data sent by or otherwise provided by the source are not to be accepted by the vehicle.

In a step 629, the autonomous vehicle effectively triggers a warning about the source. Triggering a warning may include, for example, notifying a fleet manager about the source to enable the fleet manager to take actions with respect to the source. Once autonomous vehicle triggers a warning about the source, the method of implementing a remedial process is completed.

In one embodiment, a vehicle may, upon identifying a command as illegitimate, request assistance from a teleoperations system which has the capability to remotely operate the vehicle when the vehicle is not operating autonomously as well as the capability to monitor the vehicle when the vehicle is operating autonomously. That is, a vehicle may request that a teleoperate determine a suitable course of action, or determine whether the vehicle has taken a suitable course of action, when an illegitimate command is identified. With reference to FIG. 7, a method of implementing a remedial process, e.g., step 533 of FIG. 5, which includes contacting a teleoperator will be described in accordance with an embodiment. A method 533″ of implementing a remedial process begins at a step 709 in which a vehicle ignores an illegitimate command. That is, the vehicle does not take an action contained in the illegitimate command. Ignoring the illegitimate command may include ignoring all commands coming from the source of the illegitimate command.

In a step 713, the vehicle identifies a safe location at which to stop. Once the safe location is identified, the vehicle stops at the safe location in a step 717. Then, in a step 721, the vehicle provides information relating to the illegitimate command to a teleoperator or, more generally, a teleoperations system. The information provided may include, but is not limited to including, the instructions contained in the illegitimate command, the source of the illegitimate command, and the state of the vehicle at the time the illegitimate command was obtained.

A determination is made in a step 725 as to whether instructions have been obtained from a teleoperator. In other words, the vehicle determines whether the teleoperator has instructed how the vehicle on how to proceed. If the determination is that no instructions have been obtained from a teleoperator, process flow returns to step 721 in which the vehicle may once gain provide information to the teleoperator.

Alternatively, if it is determined in step 725 that instructions have been obtained form a teleoperator, the implication is that the teleoperator has identified an appropriate course of action for the vehicle. Accordingly, process flow moves to a step 729 in which the vehicle follows the instructions provided by the teleoperator, and the method of implementing a remedial process is completed.

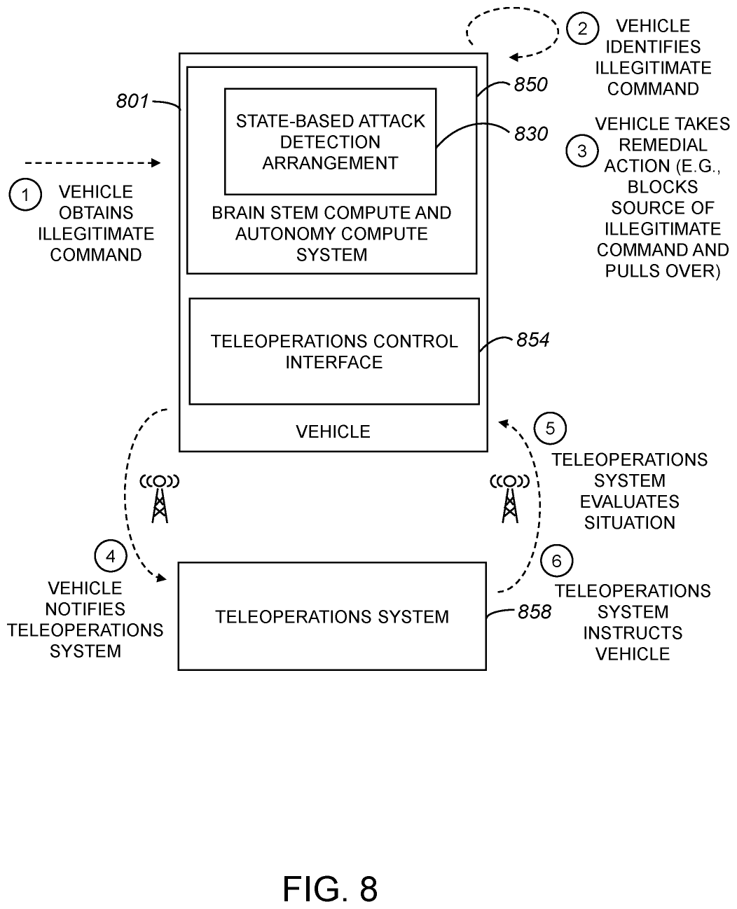

Referring next to FIG. 8, the response of a vehicle to an illegitimate command that includes communicating with a teleoperations system will be described in accordance with an embodiment. A vehicle 801 which may operate autonomously or under the control of a teleoperations system 858 includes a brain stem compute and an autonomy compute system 850 and a teleoperations control interface 854. Brain stem compute and autonomy compute system 850 includes a state-based attack detection arrangement 830. Teleoperations control interface 854 is configured to communicate with teleoperations system 858, e.g., wirelessly over a network, to enable teleoperations system 858 to control the operation of vehicle 801 when vehicle 801 is not operating in an autonomous mode. It should be appreciated that vehicle 801 generally includes systems similar to those included in vehicle 101, as described above with respect to FIG. 3.

At a time t1, vehicle 801 obtains a command, e.g., an illegitimate command, from a source. At a time t2, upon obtaining the illegitimate command, a state-based attack detection arrangement 830 identifies the illegitimate command. Identifying the illegitimate command may include, but is not limited to including, determining a current state of the vehicle, determining whether the command is consistent with the state of the vehicle, and/or determining whether a source of the command is considered to be suspect or unusual. By way of example, if a command is a command to open a door (not shown) on vehicle 801 whiles wheels (not shown) of vehicle 801 are turning, the command may be identified as illegitimate as there is a safety issue associated with opening a door of vehicle 801 while vehicle 801 is moving.

At a time t3, after identifying the command as illegitimate, vehicle 801 takes a remedial action. In one embodiment, a remedial action may include, but is not limited to including, blocking the source of the illegitimate command from sending commands and bringing vehicle 801 to a stop at a safe location.

Vehicle 801 notifies teleoperations system 858 of the illegitimate command at a time t4. Notifying teleoperations system 858 may generally include providing teleoperations system 858 with information relating to the instructions included in the illegitimate command and with information relating to the remedial action. It should be appreciated that vehicle 801 may also indicate to teleoperations system 858 that vehicle 801 will continue to take the remedial action unless teleoperations system 858 overrides vehicle 801 with a different command.

At a time t5, teleoperations system 858 evaluates the situation articulated in the notification obtained at time t4. For instance, teleoperations system 858 may monitor vehicle 801 to assess the situation. Once teleoperations system 858 has evaluated the situation, teleoperations system 858 instructs vehicle 801 accordingly at time t6. Teleoperations system 858 may generally either take control of vehicle 801 using teleoperations control interface 854 or effectively instruct brain stem compute and autonomy compute system 850 to resume operating vehicle 801 autonomously. In some embodiments, teleoperations system 858 may instruct vehicle 801 to await extraction, as for example by a tow truck. That is, teleoperations system 858 may determine that vehicle 801 may not be operated safely either autonomously or under the control of teleoperations system 858.

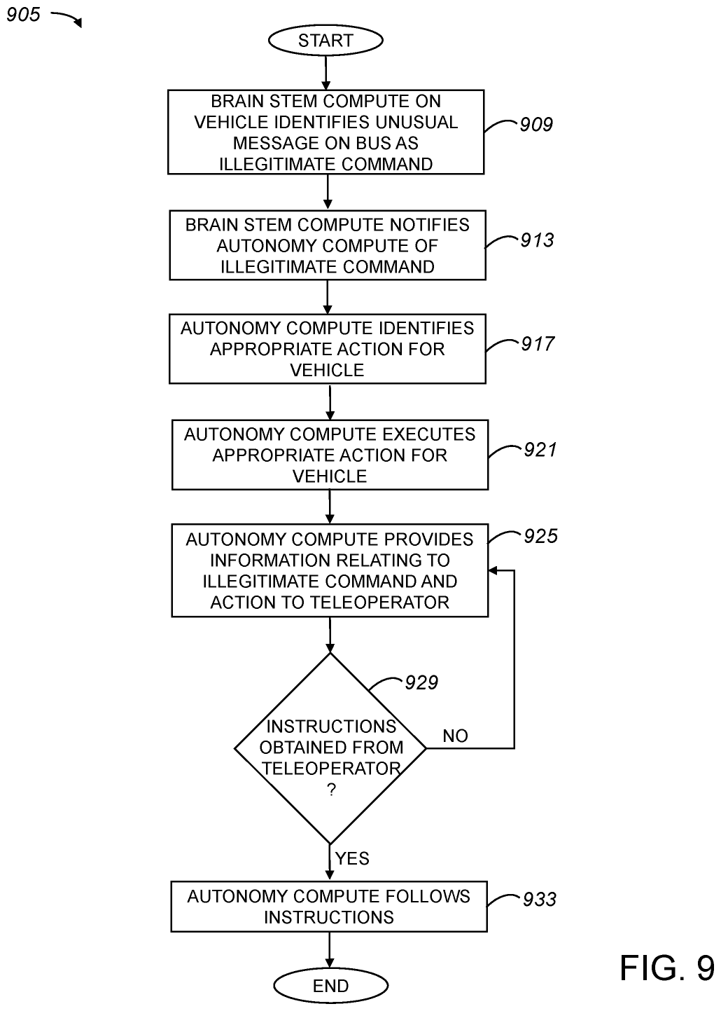

FIG. 9 is a process flow diagram which illustrates a method of responding to an illegitimate command obtained by a vehicle such as vehicle 801 of FIG. 8 in accordance with an embodiment. A method 905 of responding to an illegitimate command begins at a step 909 in which a brain stem compute on a vehicle identifies an unusual message on a bus as an illegitimate command. That is, the brain stem compute effectively detects a message on a bus that appears to be inconsistent given the current state of the vehicle. The message may generally contain or otherwise embody at least one command and/or at least one instruction.

In a step 913, the brain stem compute notifies an autonomy compute of the detection of the illegitimate command. Upon being notified by the brain stem compute, the autonomy compute identifies an appropriate action for the vehicle in a step 917. An appropriate action may include, but is not limited to including, stopping the vehicle at a safe location, continuing to operate the vehicle while ignoring the illegitimate command, etc.

Once the autonomy compute identifies an appropriate action, the autonomy compute executes the appropriate action or causes the appropriate action to be executed in a step 921. For example, the autonomy compute may cause the vehicle to navigate to a safe location, pull over, and decelerate to a stop.

After the autonomy compute executes an appropriate action for the vehicle, the autonomy compute provides information to a teleoperator, or a teleoperations system, relating to the illegitimate command and to the appropriate action taken in a step 925. In one embodiment, the autonomy compute may utilize a communications system of the vehicle to communicate with a teleoperator to provide the teleoperator with information that identifies the illegitimate command, a source of the illegitimate command, and a remedial action taken by the vehicle to address the illegitimate command.

A determination is made in a step 929 as to whether the teleoperator, upon obtaining information from the autonomy compute, has provided instructions to the vehicle. If it is determined that instructions have not be obtained from the teleoperator, as for example within a predetermined amount of time, then process flow returns to step 925 in which the autonomy compute once again provides information to the teleoperator. Alternatively, if it is determined in step 929 that instructions have been obtained from the teleoperator, the autonomy compute follows or otherwise complies with the instructions in a step 933, and the method of responding to an illegitimate command is completed.

Although only a few embodiments have been described in this disclosure, it should be understood that the disclosure may be embodied in many other specific forms without departing from the spirit or the scope of the present disclosure. By way of example, a remedial action taken by a vehicle in response to receiving or otherwise obtaining an illegitimate command has been described as including the autonomous vehicle pulling over to a safe location. In one embodiment, the vehicle may continue to operate while taking a remedial action.

An illegitimate command has been described as being a command or instruction issued by a malicious actor. An illegitimate command is not limited to being a command issued by a malicious actor. For instance, and illegitimate command may be the result of a malfunction of a system that is either on a vehicle or in communication with a vehicle. In other words, an illegitimate or inconsistent command may be received on a vehicle due to an error and not due to a purposeful action by a malicious actor.

In general, a command may be a message structure that substantially governs the interchange of data, and includes at least one instruction that essentially identifies an action to be taken by a vehicle. That is, a command may effectively be, but is not limited to being, a directive to a vehicle, or to systems on a vehicle to perform a task or a function.

An autonomous vehicle has generally been described as a land vehicle, or a vehicle that is arranged to be propelled or conveyed on land. It should be appreciated that in some embodiments, an autonomous vehicle may be configured for water travel, hover travel, and or/air travel without departing from the spirit or the scope of the present disclosure. In general, an autonomous vehicle may be any suitable transport apparatus that may operate in an unmanned, driverless, self-driving, self-directed, and/or computer-controlled manner.

The embodiments may be implemented as hardware, firmware, and/or software logic embodied in a tangible, i.e., non-transitory, medium that, when executed, is operable to perform the various methods and processes described above. That is, the logic may be embodied as physical arrangements, modules, or components. For example, the systems of an autonomous vehicle, as described above with respect to FIG. 3, may include hardware, firmware, and/or software embodied on a tangible medium. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. Therefore, the present examples are to be considered as illustrative and not restrictive, and the examples are not to be limited to the details given herein, but may be modified within the scope of the appended claims.

What is claimed is:

1. A method comprising:
obtaining a command on a vehicle, the command being arranged to identify a first action to be taken by the vehicle, wherein the vehicle is in a first vehicle state and the command has a first command state;
determining, on the vehicle, whether the first command state is consistent with the first vehicle state;
when it is determined that the first command state is consistent with the first vehicle state, executing the first command; and
when it is determined that the first command state is not consistent with the first vehicle state, identifying the first command as an illegitimate command and ignoring the illegitimate command.

2. The method of claim 1 wherein when it is determined that the first command state is not consistent with the first vehicle state, the method further includes:
causing the vehicle to take a remedial action.

3. The method of claim 2 wherein the command is issued by a source, and wherein the remedial action includes preventing the source from sending additional commands to the vehicle.

4. The method of claim 2 wherein the remedial action includes causing the vehicle to come to a stop.

5. The method of claim 2 when it is determined that the first command state is not consistent with the first vehicle state, the method further includes:
providing information relating to the illegitimate command to a teleoperations system.

6. The method of claim 5 wherein the information relating to the illegitimate command includes information that identifies the illegitimate command and information that identifies the remedial action.

7. The method of claim 1 wherein the command identifies an action to be taken by the vehicle, and wherein determining, on the vehicle, whether the first command state is consistent with the first vehicle state includes:
determining whether the action is expected when the vehicle is in the first vehicle state, wherein when the action is not expected when the vehicle is in the first vehicle state, the first command state is not consistent with the first vehicle state.

8. A vehicle comprising:
a chassis;
a propulsion system configured to propel the chassis;
a power system carried on the chassis, the power system configured to provide power;
a first compute system carried on the chassis, the first compute system including an attack detection system, the attack detection system configured to obtain a command provided to the vehicle, the command having a first command state, and configured to determine whether the first command state is consistent with a current vehicle state of the vehicle; and
an autonomy system carried on the chassis, wherein when the first compute system determines that the first command state is not consistent with the current vehicle state, the first compute system identifies the command as an illegitimate command and notifies the autonomy system of the illegitimate command, the autonomy system being arranged to identify an appropriate action to take in response to the illegitimate command and to execute the appropriate action.

9. The vehicle of claim 8 further including:
a teleoperations interface, the teleoperations interface configured to interface with a teleoperations system that remotely operate the vehicle, wherein the autonomy system is arranged to provide information relating to the illegitimate command to the teleoperations system.

10. The vehicle of claim 9 wherein the information relating to the illegitimate command includes information that identifies the illegitimate command and information that identifies the appropriate action.

11. The vehicle of claim 8 wherein the command defines an action to be taken by the vehicle and the first attack detection system is configured to determine whether the first command state is consistent with the current vehicle state of the vehicle at least by determining whether the action is expected when the vehicle is in the current vehicle state, wherein when the action is not expected when the vehicle is in the current vehicle state, the first command state is not consistent with the current vehicle state.

12. A vehicle including logic encoded in one or more tangible non-transitory, computer-readable media for execution and when executed operable to:
obtain a command, the command being arranged to identify a first action to be taken by the vehicle, wherein the vehicle is in a first vehicle state and the command has a first command state;
determine whether the first command state is consistent with the first vehicle state;
execute the first command when it is determined that the first command state is consistent with the first vehicle state;
identify the first command as an illegitimate command when it is determined that the first command state is not consistent with the first vehicle state; and
ignore the illegitimate command after identifying the first command as the illegitimate command.

13. The vehicle of claim 12 wherein when it is determined that the first command state is not consistent with the first vehicle state, the logic is further operable to:
cause the vehicle to take a remedial action.

14. The vehicle of claim 13 wherein the command is issued by a source, and the logic operable to cause the vehicle to take the remedial action is further operable to prevent the source from providing additional commands to the vehicle.

15. The vehicle of claim 13 wherein the logic operable to cause the vehicle to take the remedial action is further operable to cause the vehicle to come to a stop.

16. The vehicle of claim 13 when it is determined that the first command state is not consistent with the first vehicle state, the logic is further operable to:
provide information relating to the illegitimate command to a teleoperations system.

17. The vehicle of claim 16 wherein the information relating to the illegitimate command includes information that identifies the illegitimate command and information that identifies the remedial action.

18. The vehicle of claim 12 wherein the command identifies an action to be taken by the vehicle, and wherein the logic operable to determine whether the first command state is consistent with the first vehicle state is operable to:
determine whether the action is expected when the vehicle is in the first vehicle state, wherein when the action is not expected when the vehicle is in the first vehicle state, the first command state is not consistent with the first vehicle state.

19. The vehicle of claim 12 wherein the logic is further operable to:
cause the vehicle to operate autonomously.

20. The vehicle of claim 12 wherein the logic is further operable to:
cause the vehicle to be operated by a teleoperations system.
